(19) United States
(12) Patent Application Publication
(10) Pub. No.: US 2006/0035125 A1
(43) Pub. Date: Feb. 16, 2006

(54) Fuel cell system

(75) Inventors: Goro Fujita, Ota-si (JP); Kenji Kibune, Ora-Gun (JP); Hiroki Kabumoto, Saitama-si (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/200,146

(22) Filed: Aug. 10, 2005

(30) Foreign Application Priority Data
Aug. 10, 2004 (JP) 2004-233288
Feb. 8, 2005 (JP) 2005-032095

(51) Int. Cl. H01M 8/04

(52) U.S. Cl. 429/26; 429/34

(57) ABSTRACT

A DMFC system which realizes appropriate temperature management on a methanol aqueous solution and on a DMFC with consideration given to the activity of methanol oxidation reaction between electrodes and suppression of degradation of solid polymer films. The fuel cell system according to the present invention comprises: a fuel cell which generates electric power by using liquid fuel; a fuel feed unit which feeds the liquid fuel to the fuel cell; an emission recovery unit which recovers emissions from the fuel cell; and a heat medium feed unit which feeds a heat medium for cooling the emissions to the emission recovery unit. Here, the heat medium cools the fuel cell.

### BACKGROUND OF THE INVENTION

1. Field of the Invention

The invention relates to a direct methanol fuel cell system. In particular, the invention relates to a temperature management structure for operating a direct methanol fuel cell system with stability.

2. Description of the Related Art

Fuel cells are devices for generating electric energy from hydrogen and oxygen, and are capable of providing high generation efficiency. Among the chief characteristics of the fuel cells are: high generation efficiency is expected even in smaller scales because of the direct generation mode without thermal- or kinetic-energy processes as in conventional generation modes; and excellent environmental friendliness is obtained from low emission of nitrogen compounds as well as reduced noise and vibrations. Since the fuel cells can thus use the chemical energy of the fuel effectively and have the environment-friendly characteristic, they are expected as energy supply systems to bear the 21st century. In various applications ranging from large-scale power generation to small-scale power generation, including space technologies, automobiles, and portable devices, the fuel cells are attracting attention as promising novel generation systems. Technological development toward practical use has thus been made in earnest.

Above all, solid polymer type fuel cells are characterized in lower operating temperatures and higher output densities as compared to the other types of fuel cells. Among various forms of solid polymer type fuel cells, a direct methanol fuel cell (DMFC) has recently been gaining attention in particular. In the DMFC, a methanol aqueous solution, the fuel, is fed directly to the anode without any modification so that electricity is generated through the electrochemical reaction between the methanol aqueous solution and oxygen. During this electrochemical reaction, carbon dioxide is emitted from the anode and produced water from the cathode as reaction products. As compared to hydrogen, the methanol aqueous solution provides higher energy per unit volume, is well-suited to storage, and has low risk of explosion or the like. Applications such as the power sources of automobiles and cellular phones are thus expected.

This DMFC has operating temperatures ranging from 40° C. to 100° C. or so. Operation in a higher temperature range increases the activity of methanol oxidation reaction between the electrodes. This can increase the current density per unit area of the electrodes for improved performance. Meanwhile, the methanol aqueous solution has a low boiling point. Unless the exhausted methanol aqueous solution emitted from the anode is cooled and condensed sufficiently, methanol might be released to exterior with an increase in methanol consumption. For this reason, the DMFC adopts the configuration of conducting heat exchange between the methanol aqueous solution to be fed to the anode and the emissions from the anode and the cathode (the exhausted methanol aqueous solution and the produced water). (For example, see Japanese Patent Laid-Open Publication No. 2004-178818)

As described above, the DMFC improves in performance when it is operated in a higher temperature range. Nevertheless, solid polymer films for use in solid polymer type fuel cells including the DMFC are soluble to organic solvents. In particular, this solubility becomes significant when the organic solvents are increased in temperature. Then, if the operating temperature of the DMFC is raised so that a methanol aqueous solution of or above 75° C. makes contact with the solid polymer films, there occurs the problem that the solid polymer films are dissolved to promote degradation of the solid polymer films inside the DMFC with a significant drop in the life (reliability) of the DMFC. It is thus preferable that the DMFC is operated in the temperature range of 50° C. to 70° C., and desirably 60° C.±3° C.

The methanol aqueous solution to be fed to the DMFC is adjusted to 0.5 to 4 mol/L, and desirably 0.8 to 1.5 mol/L, in concentration. Since methanol has a boiling point of 64.7° C., the methanol aqueous solution reaching or exceeding 65° C. in temperature can cause methanol evaporation easily in the flow channels of the methanol aqueous solution. This also causes problems such as increased methanol consumption due to external emission and hindered dispersion of the methanol aqueous solution on the electrodes.

### SUMMARY OF THE INVENTION

The present invention has been achieved in view of the foregoing problems. It is thus an object of the present invention to provide a DMFC system which realizes appropriate temperature management both on the methanol aqueous solution in its flow channels and on the DMFC with consideration given to the activity of the methanol oxidation reaction between the electrodes and suppression of degradation of the solid polymer films.

To achieve the foregoing object, the present invention provides a fuel cell system comprising: a fuel cell which generates electric power by using liquid fuel; a fuel feed unit which feeds the liquid fuel to the fuel cell; an emission recovery unit which recovers emissions from the fuel cell; and a heat medium feed unit which feeds a heat medium for cooling the emissions to the emission recovery unit. Here, the heat medium cools the fuel cell.

As employed herein, the fuel feed unit shall refer to piping or the like intended to feed a liquid fuel such as methanol to the fuel cell. With a fuel cell of active type, the fuel feed unit may include a force feed unit such as a pump, and a tank for storing the liquid fuel. The emission recovery unit shall refer to piping or the like intended to recover emissions from the anode of the fuel cell, including carbon dioxide and exhausted fuel such as the exhausted methanol aqueous solution, and emissions from the cathode, including produced water and exhausted oxidants such as the exhausted air. If necessary, the emission recovery unit may include a pump for exhaustion, and a separator for separating components not to be reused for generation, such as carbon dioxide, and discharging them to outside the system. According to the foregoing configuration, emissions reusable for generation can be cooled and condensed sufficiently for circulation without being wastefully discharged to outside the system. The fuel cell can also be stabilized in temperature.

In addition to the foregoing configuration, the emission recovery unit may be provided with a heat exchange unit which conducts heat exchange between the heat medium and the emissions, and conducts heat exchange between the liquid fuel to be fed to the fuel cell and the emissions. Aside from the heat exchange between the heat medium and the emissions, the additional heat exchange is conducted between the liquid fuel to be fed to the fuel cell and the emissions. The emissions are thus reduced further in temperature for sufficient condensation. Moreover, since the liquid fuel fed to the fuel cell is raised in temperature, methanol oxidation reaction starts immediately when the liquid fuel permeates the anode.

The heat medium may be a fluid that lies outside the fuel cell system. The heat medium may be discharged to outside the fuel cell system after it cools the fuel cell and the emissions. In this case, since the heat medium is fluid, it is possible to feed the heat medium into the fuel cell system by such heat medium feed unit as a fan and a compressor. This fluid cools the emissions from the fuel cell and the fuel cell itself, and is exhausted to exterior. Temperature management can thus be exercised on the fuel cell system with a simple mechanism.

The fuel cell system may also comprise: an internal fuel cell chamber in which the fuel cell and the emission recovery unit are arranged; a heat medium inlet part formed on the fuel cell chamber, through which the heat medium flows into the fuel cell chamber; and a heat medium outlet part formed on the fuel cell chamber, through which the heat medium flows out of the fuel cell chamber. Here, the heat medium flowing through the fuel cell chamber may be let in through the heat medium inlet part alone and let out through the heat medium outlet part alone. Since the inlet and outlet of the heat medium to flow through the fuel cell chamber are thus limited, it becomes possible to set the courses of flow and the flow rates in the respective flow channels arbitrarily. This facilitates the temperature management inside the fuel cell system. Moreover, when the heat medium is such a fluid as the air outside the fuel cell system, the air is prevented from flowing into and out of the fuel cell chamber from/to the other areas of the fuel cell system. It is therefore possible to preclude air accompanied by water vapor from flowing out toward electronic components of the control unit and the like where moisture must be avoided.

The fuel cell and the heat medium inlet part may be arranged next to each other. The heat exchange unit and the heat medium outlet part may also be arranged next to each other. In this arrangement, the heat medium having a still lower temperature is fed to the fuel cell while the heat medium having increased in temperature through the heat exchange with the fuel cell is fed to the heat exchanger unit. The fuel cell and the emissions, and even the liquid fuel to be fed to the fuel cell, can thus be set at appropriate temperatures.

The fuel cell may have a polygonal shape, and at least one of sides of the fuel cell may be put next to the flow channel of the heat medium. In particular, the fuel cell has end plates which are typically made of metal and are high in heat radiation. At least the surfaces of these end plates can be put in contact with the flow channel of the heat medium for the sake of appropriate temperature management on the fuel cell.

### BRIEF DESCRIPTION OF THE DRAWINGS

FIG. 1 is a schematic diagram showing the configuration of a DMFC system according to embodiment 1;

FIG. 2 is a perspective view of the DMFC system according to practical example 1;

FIG. 3 is a top view of the DMFC system according to practical example 1;

FIG. 4 is a sectional view of the DMFC system according to practical example 1, taken along the line A-A′ of FIG. 3;

FIG. 5 is a system block diagram schematically showing the configuration of a fuel cell system according to practical example 2;

FIG. 6 is a top view of the fuel cell system according to practical example 2, where the case of the fuel cell unit is opened;

FIG. 7 is a front view of the fuel cell system according to practical example 2, where the case of the fuel cell unit is opened;

FIG. 8 is a perspective front view of the fuel cell system according to practical example 2, where the case of the fuel cell unit is opened;

FIG. 9 is a perspective front view of the fuel cell system according to practical example 2;

FIG. 10 is a perspective back view of the fuel cell system according to practical example 2;

FIG. 11A is a front view of the fuel cell system according to practical example 2, showing the flow of air in the fuel cell unit;

FIG. 11B is a top view of the fuel cell system according to practical example 2, showing the flow of air in the fuel cell unit;

FIG. 12 is a system block diagram schematically showing the configuration of the fuel cell system according to practical example 2 which is separated into the fuel cell unit and a control unit;

FIG. 13 is a system block diagram schematically showing the configuration of a fuel cell system according to practical example 3; and

FIG. 14 is a system block diagram schematically showing the section taken along the line A-A′ of FIG. 13.

### DETAILED DESCRIPTION OF THE INVENTION

### Embodiment 1

The configuration of a DMFC system 100 according to the present embodiment will be described in detail with reference to the drawings.

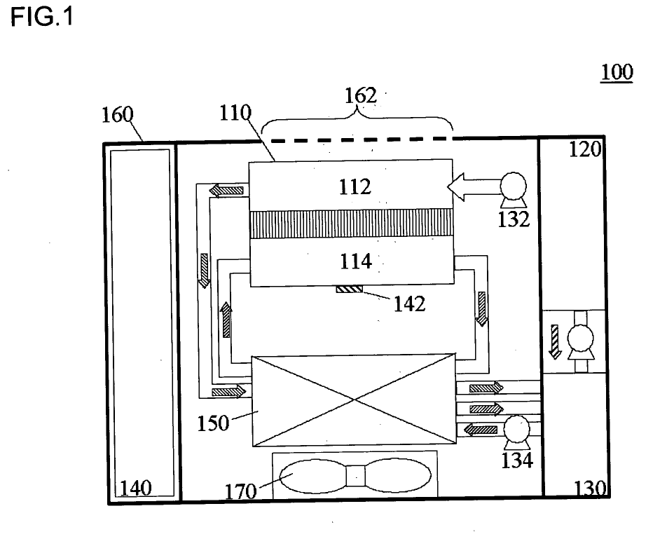

FIG. 1 is a schematic diagram showing the configuration of the DMFC system 100 according to the present embodiment. The DMFC system 100 comprises a DMFC 110, a methanol tank 120, a buffer tank 130, a control unit 140, a heat exchanger 150, a case 160, and an axial fan 170. The methanol tank 120 contains a high-concentration methanol aqueous solution of or above 20 mol/L, or pure methanol. The methanol from the methanol tank 120 is diluted into concentrations of 1.2 mol/L or so, and reserved in the buffer tank 130 as the methanol aqueous solution to be fed to the DMFC 110. The control unit 140 exercises control on power conversion units and accessories.

An air pump 132 feeds air to the cathode 112 of the DMFC 110. The anode 114 is fed with the methanol aqueous solution from the buffer tank 130 via a liquid pump 134. The cathode 112 of the DMFC 110 emits exhausted air not involved in power generation, and moisture produced by reaction. The anode 114 emits an exhausted methanol aqueous solution not involved in power generation, and carbon dioxide produced by the reaction. The DMFC 110 generates electric power through exothermic reaction. Feeding the DMFC 110 with the air and the methanol aqueous solution thus increases the temperature of the DMFC 110. Then, the DMFC 110 is provided with a thermistor 142 or a limiter, and the axial fan 170 starts operation when the temperature of the DMFC 110 reaches 55° C. The case 160 has an air vent 162 which is formed in the position opposite from the axial fan 170. When the axial fan 170 starts operation, air flows around the DMFC 110 to cool the DMFC 110. This makes it possible to set the temperature of the DMFC 110 at 60° C.±3° C.

Since the air pump 132 introduces air from exterior, the air fed to the cathode 112 is around 20° C. to 25° C. The DMFC 110 is thus set at 60° C.±3° C. in temperature by the air cooling of the axial fan 170. This DMFC 110 emits the exhausted air, the moisture, the exhausted methanol aqueous solution, carbon dioxide, and the like of around 70° C. Then, heat exchange is conducted with the methanol aqueous solution to be fed to the DMFC 110, so that the emissions including the exhausted air, the moisture, the exhausted methanol aqueous solution, and carbon dioxide are condensed and the methanol aqueous solution to be fed to the DMFC 110 is warmed in advance. Here, the amount of exhausted heat from the exhausted air, the moisture, the exhausted methanol aqueous solution, carbon dioxide, and the like is greater than the amount of heat necessary to warm the methanol aqueous solution. Thus, the heat exchanger 150 is also air-cooled by the axial fan 170. As a result, the moisture and the exhausted methanol aqueous solution are condensed sufficiently. This can eliminate the need to supply moisture from exterior, and prevent methanol from being released to exterior with an increase in consumption.

Now, a specific structure of the DMFC system 100 for achieving the foregoing configuration will be described in conjunction with a practical example thereof.

### PRACTICAL EXAMPLE 1

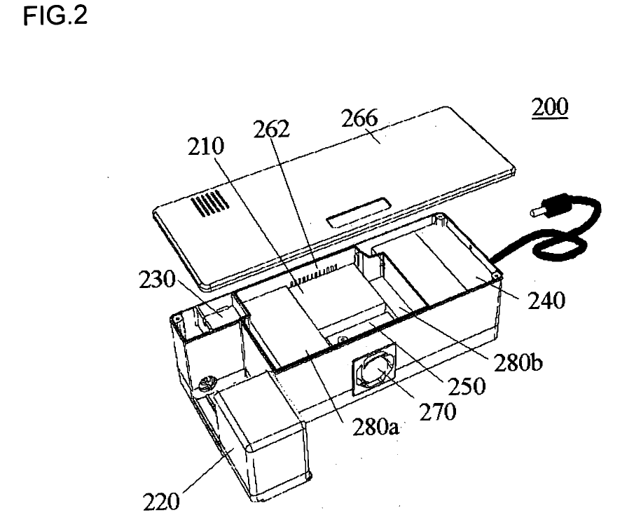

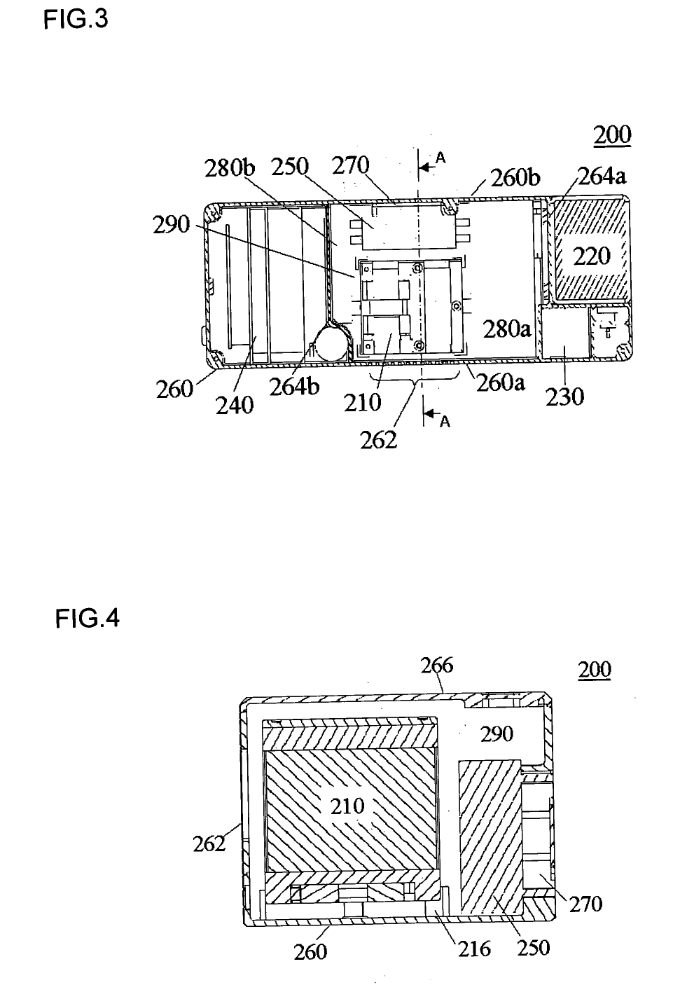

FIG. 2 is a perspective view of a DMFC system 200 according to this practical example. FIG. 3 is a top view of the DMFC system 200. FIG. 4 is a sectional view of the DMFC system 200, taken along the line A-A′ of FIG. 3.

In practical example 1, a DMFC 210, a methanol tank 220, a buffer tank 230, a control unit 240, a heat exchanger 250, and an axial fan 270 are arranged as shown in FIG. 2. The piping and pumps for feeding and exhausting the air and the methanol aqueous solution are unitized as indicated by 280a and 280b, and arranged on the respective sides of the DMFC 210 and the heat exchanger 250.

As shown in FIG. 3, clearances of the order of several millimeters are provided between the DMFC 210 and the piping units 280a and 280b. Both sides of the DMFC 210 make flow channels for the cooling air. The sides 260a and 260b and wall surfaces 264a and 264b of a case 260 are in tight contact with a lid 266 of the DMFC system 200 so that a fuel cell chamber 290 including the DMFC 210 enclosed by these sides and surfaces are shut off from exterior. The fuel cell chamber 290 is thus configured so that air is fed through an air vent 262 alone and the air is exhausted through the axial fan 270 alone. The DMFC 210 is placed several millimeters or so away from the side 260a having the air vent 262, so as not to interrupt the air flowing in through the air vent 262.

As shown in FIG. 4, a spacer 216 is arranged on the bottom of the DMFC 210, so that a cooling-air flow channel of several millimeters or so is formed as if on both sides of the DMFC 210. A cooling-air flow channel of several millimeters or so is also formed between the top of the DMFC 210 and the lid 266. In this practical example, the top and bottom sides of the DMFC 210 are made of metal end plates 218a and 218b, which are higher in heat radiation than the other sides of the DMFC 210. In particular, the end plate 218b at the bottom becomes the highest in temperature and in heat radiation since it is provided with the feed channel of the methanol aqueous solution to the anode and the exhaust channel of the exhausted air and moisture from the cathode. Consequently, the DMFC 210 can be cooled effectively by installing the spacer 216 at the bottom to circulate the cooling air.

As above, the clearances of several millimeters or so established around the DMFC 210 make the flow channels of the cooling air. The air introduced from the air vent 262 thus hits the DMFC 210, flows over the top, bottom, and sides of the DMFC 210 to remove the reaction heat for generation from the DMFC 210, and flows into the heat exchanger 250. Here, the air flowing into the heat exchanger 250 has temperatures of 30° C. to 35° C. at the point in time when the DMFC 210 exceeds 55° C. in temperature and the axial fan 270 starts operation. The air has temperatures of around 40° C. when the DMFC 210 is in its normal generation state near 60° C.

Returning to FIG. 2, the exhausted air and moisture emitted from the cathode of the DMFC 210 and the exhausted methanol aqueous solution, carbon dioxide, and the like emitted from the anode flow into the heat exchanger 250 at around 70° C. when in the normal generation state. For sufficient condensation, the moisture and the exhausted methanol aqueous solution from the DMFC 210 are cooled by the methanol aqueous solution to be fed to the DMFC 210 and the air introduced from the air vent 262, the air having absorbed the reaction heat for generation from the DMFC 210. This heat exchange warms the methanol aqueous solution to be fed to the DMFC 210 to around 60° C. from its normal temperatures of 35° C. or so as will be described later. The moisture and the exhausted methanol aqueous solution from the DMFC 210 are cooled to around 40° C. Here, carbon dioxide emitted from the DMFC 210 shows a sharp increase in solubility if the solvent falls below 30° C. in temperature. It is therefore desirable that the heat exchanger 250 not cool the moisture and the exhausted methanol aqueous solution to below 35° C. or so.

The exhausted air, the moisture, the exhausted methanol aqueous solution, carbon dioxide, and the like cooled by the heat exchanger 250 flow into the buffer tank 230 for gas-liquid separation. Since the exhausted air, the moisture, the exhausted methanol aqueous solution, carbon dioxide, and the like flowing into the buffer tank 230 are previously cooled to around 40° C. by the heat exchanger 250, the buffer tank 230 usually has temperatures of around 35° C. inside. Gas components such as the exhausted air and carbon dioxide are thus released to exterior, while the moisture and the exhausted methanol aqueous solution are fed to the DMFC 210 again.

[Other Respects]

In the foregoing practical example 1, the air vent 262 is formed in a vertically- and horizontally-symmetrical position so that the cooling air flows over the top, the bottom, and both sides of the DMFC 210 evenly. Nevertheless, if the heat radiation from the top and the bottom is higher than that from the sides, for example, the position and size of the air vent 262, the height of the spacer 216, and the distance between the DMFC 210 and the lid 266 may be changed so that the amount of air flowing over the top and the bottom increases.

The fuel cell chamber 290 is configured so that air flows in through the air vent 262 and is exhausted by the axial fan 270. Nevertheless, air may be introduced into the fuel cell chamber 290 by using the axial fan 270 and emitted out of the air vent 262. In such a case, the heat exchanger 250 is preferably arranged near the air vent 262, and the DMFC 210 near the axial fan 270, so as to achieve the same heat distribution as in the foregoing practical example 1. Moreover, in the foregoing practical example 1, the air is exhausted by using the axial fan 270. The device for introducing air into the fuel cell chamber 290 is not limited to the axial fan 270, but may be a sirocco fan, a compressor, or the like.

### INDUSTRIAL APPLICABILITY

The present embodiment allows appropriate temperature management inside the DMFC system and thereby allows stable operation when electronic equipment is used while both the electronic equipment and the DMFC system for supplying power to the electronic equipment are placed on a desk. It is also possible to place the DMFC system without the exhausted heat being directed toward the user.

### Embodiment 2

The present embodiment relates to a fuel cell system. In particular, the present embodiment relates to a fuel cell system which can minimize the electric power to be consumed by accessories of the fuel cell system.

The fuel cell generates electric power through exothermic electrochemical reaction. As described above, the methanol aqueous solution to be fed to the anode thus gradually increases in temperature during circulation, and circulates at temperatures around 5° C. to 40° C. higher than the outside air temperature. The methanol aqueous solution is thus fed as warmed up to temperatures around 5° C. to 10° C. lower than the operating temperature of the DMFC.

Meanwhile, oxygen is fed to the cathode of the DMFC in either of the following modes. In one mode, air outside the DMFC system is fed directly to the DMFC at temperatures near equal to the outside air temperature by using a feed unit such as an air pump. Alternatively, as is the case with the anode, the air outside the DMFC system is subjected to heat exchange with the emissions from the DMFC so that it is fed as warmed up to temperatures around 5° C. to 10° C. lower than the operating temperature of the DMFC. In the former case, the air of 10° C. to 30° C. is fed to the DMFC which is operating at 40° C. to 100° C. This lowers the temperatures near the air inlets of respective cells, thereby producing the problem that the activity of the methanol oxidation reaction in these areas drops with a decrease in current density. Besides, the current densities inside the cells can fluctuate to cause variations in the speed of degradation, thereby producing areas where degradation proceeds rapidly. This results in the problem that the life of the entire DMFC becomes shorter. Now, in the latter case, another heat exchanger is required for the cathode side, which produces the problem that the DMFC system becomes greater in configuration. Moreover, since the heat exchanger increases the pressure loss in the feed channel of the air and requires an air pump of greater capacity accordingly, there also occurs the problem that the accessories of the DMFC system increase in power consumption.

(Means for Solving the Problems of the Present Embodiment)

The present embodiment has been achieved in view of the foregoing problems. It is thus an object of the present embodiment to provide a fuel cell system which can minimize the power consumption of the accessories of the fuel cell system.

To achieve the foregoing object, the present embodiment provides a fuel cell system comprising: a fuel cell which generates electric power from fuel and oxygen in air; an air feed unit which feeds the air to the fuel cell; and an air flow channel which introduces the air from outside the fuel cell system and exhausts air inside the fuel cell system to outside. Here, an air intake of the air feed unit is formed in the air flow channel.

Consequently, the air inside the fuel cell system is introduced from the air intake. Since the temperature inside the fuel cell system is higher than the outside air temperature due to heat radiation from the fuel cell, the air introduced from the air intake becomes higher in temperature than the air outside the fuel cell system. This eliminates the need to warm the air with a heat exchanger or the like before feeding it to the fuel cell. Consequently, it is possible to reduce the power to be consumed by the air feed unit such as an air pump.

In the fuel cell system of the foregoing aspect, the fuel cell may be arranged in the air flow channel. Moreover, in the fuel cell system of the foregoing aspect, the fuel may be liquid fuel. The fuel cell is arranged in the air flow channel, and thus the fuel cell can be air-cooled when the air inside the fuel cell system is exhausted to outside. Then, with a type of fuel cells to be fed with liquid fuel, such as a DMFC system which is gaining attention recently, it is possible to reduce the power consumption of the accessories including the air feed unit and reduce the parts count of the fuel cell system as well.

The fuel cell system according to the foregoing aspect may comprise a heat exchanger which conducts heat exchange between the air and emissions emitted from the fuel cell. The heat exchanger may be arranged in the air flow channel. This makes it possible to cool and condense the emissions emitted from the fuel cell, such as produced water. With a fuel cell to be fed with liquid fuel in particular, the liquid fuel exhausted from the fuel cell can be condensed to reduce the amount of liquid fuel to be released to outside the fuel cell system.

The fuel cell system according to the foregoing aspect may comprise a fuel cell unit including the fuel cell, and a control unit which controls the fuel cell. The fuel cell unit and the control unit may be configured separable from each other. Consequently, the fuel cell unit for power generation can be made common for various applications.

Hereinafter, the configuration of the fuel cell system according to the present embodiment will be described in detail with reference to the drawings.

### PRACTICAL EXAMPLE 2

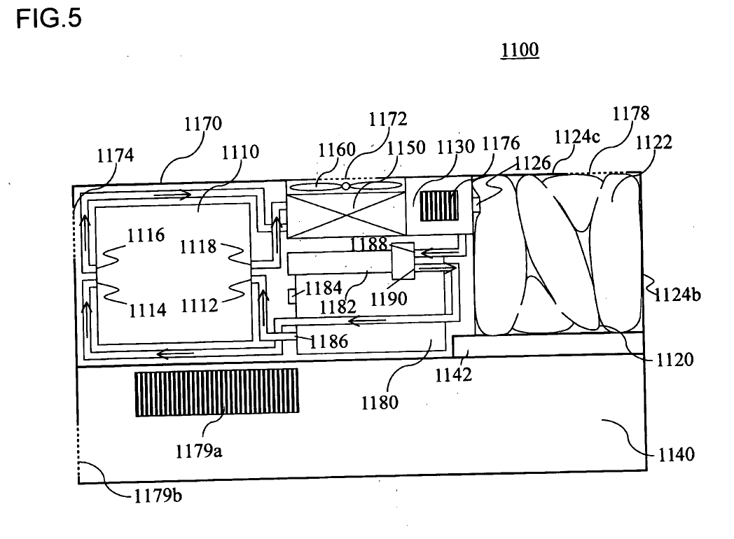

FIG. 5 is a schematic top view showing the configuration of a fuel cell system 1100. The fuel cell system 1100 comprises a DMFC 1110, a methanol tank 1120, a buffer tank 1130, a control unit 1140, a heat exchanger 1150, an axial fan 1160, and a case 1170. A methanol aqueous solution or pure methanol is fed to the anode of the DMFC 1100 for power generation. The methanol tank 1120 contains a high-concentration methanol aqueous solution of or above 16 mol/L, or pure methanol. The methanol from the methanol tank 1120 is diluted into concentrations of 0.1 to 2.0 mol/L or so, and reserved in the buffer tank 1130 as the methanol aqueous solution to be fed to the DMFC 1110. The control unit 1140 exercises control on power conversion units and accessories.

An air pump 1180 feeds air to the cathode of the DMFC 1110. The anode is fed with the methanol aqueous solution from the buffer tank 1130 via a liquid pump 1182. The reference numeral 1184 represents an air intake of the air pump 1180, which is formed in the center of this fuel cell system 1100. The air introduced from the air intake 1184 of the air pump 1180 is delivered from an air discharge opening 1186 into a cathode inlet 1112 of the DMFC 1110. Meanwhile, the liquid pump 1182 is configured so that the methanol aqueous solution diluted to concentrations of 1.2 mol/L or so is introduced from the buffer tank 1130 to a liquid intake 1188, and delivered from a liquid discharge opening 1190 into an anode inlet 1114 of the DMFC 1110.

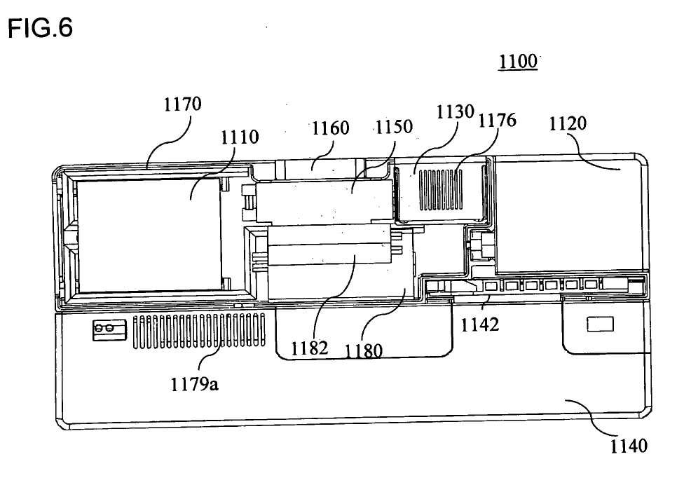

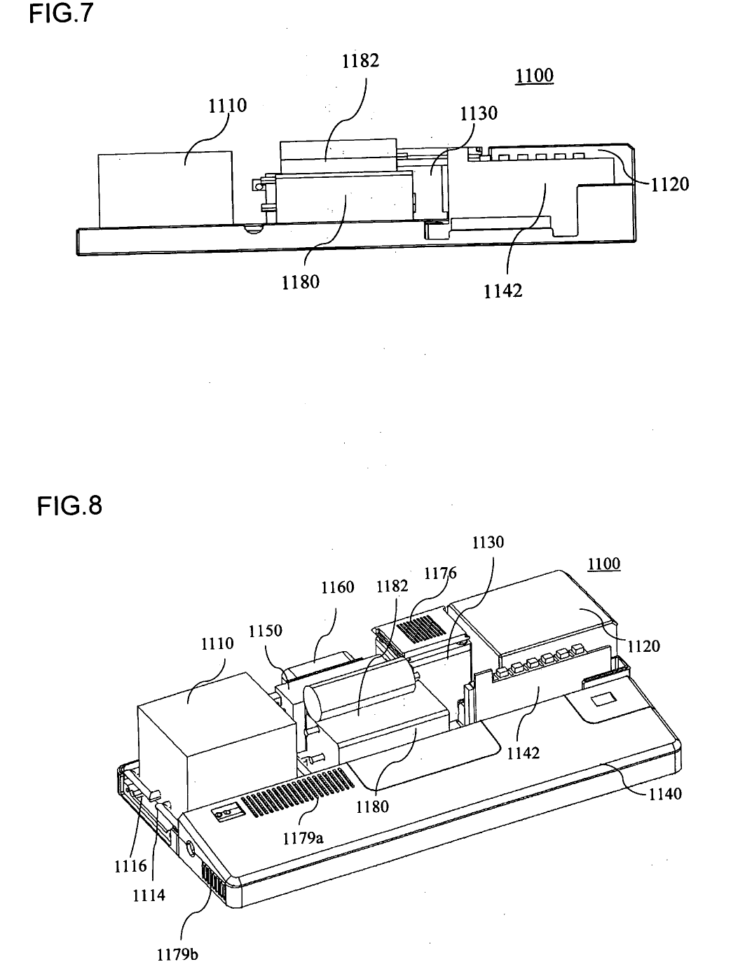

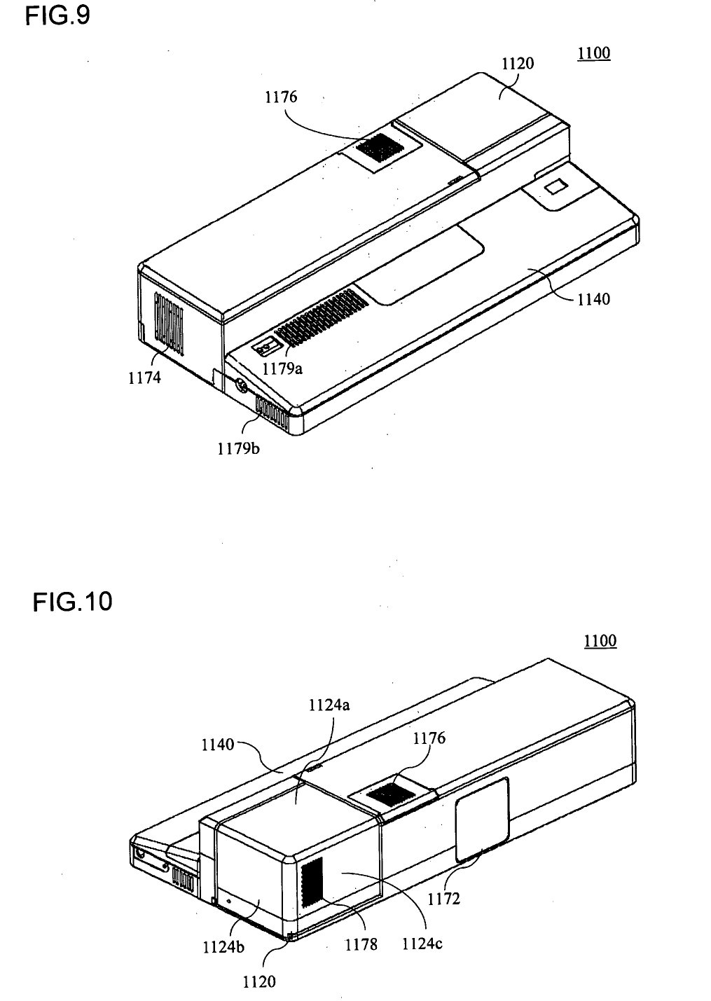

FIG. 6 is a top view of the fuel cell system 1100 which is assembled in the foregoing configuration. FIG. 7 is a front view of the same, and FIG. 8 is a perspective front view of the same. FIG. 9 is a perspective front view of the same, showing the state where a lid is attached to the fuel cell unit. FIG. 10 is a perspective back view showing the state where the lid is attached to the fuel cell unit.

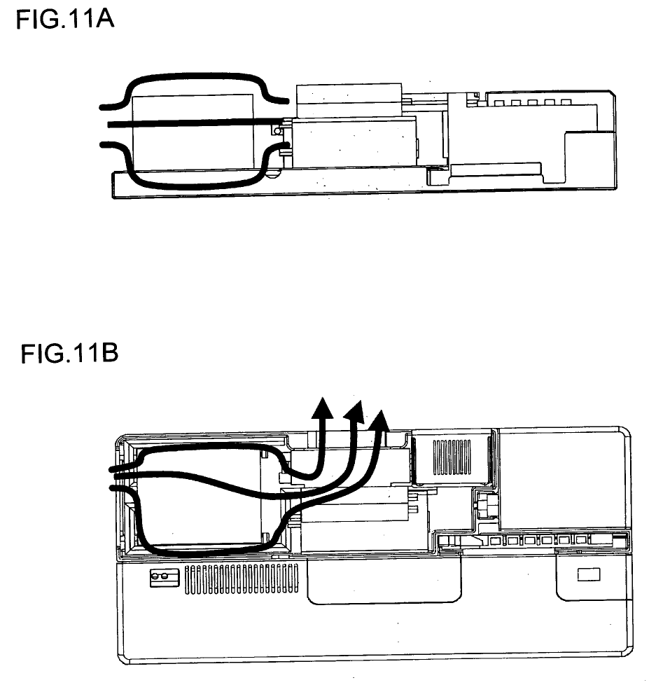

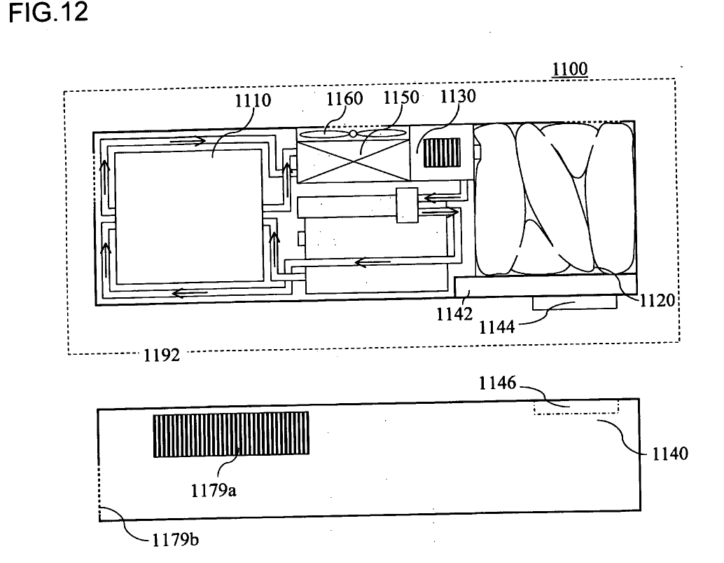

The DMFC 1110 generates electric power through exothermic reaction. Feeding the DMFC 1110 with the air and the methanol aqueous solution thus increases the temperature of the DMFC 1110. Then, the DMFC 1110 is provided with a not-shown thermistor or limiter, and the axial fan 1160 starts operation when the temperature of the DMFC 1110 reaches but around −5° C. from the operating temperatures (60° C.±3° C.) (in this practical example, 55° C.). The case 1170 has an air vent 1172 which is formed in the position opposite to the axial fan 1160, and an air vent 1174 which is formed in a position beyond the DMFC 1110. Consequently, when the axial fan 1160 starts operation, air flows around the DMFC 1110 to cool the DMFC 1110 as shown in FIGS. 11A and 11B. The temperature of the DMFC 1110 can thus be set at 60° C.±3° C.

The cathode of the DMFC 1110 emits the air and the produced water from a cathode outlet 1116. The anode of the DMFC 1110 emits the methanol aqueous solution and carbon dioxide from an anode outlet 1118. The emissions from the cathode outlet 1116 and the anode outlet 1118 are introduced into the heat exchanger 1150, and flow into the buffer tank 1130 together. The air intake 1184 and the heat exchanger 1150 are fed with air having temperatures around 5° C. to 15° C. lower than the operating temperatures (60° C.±3° C.) of the DMFC 1110. Consequently, the air, the produced water, the methanol aqueous solution, carbon dioxide, and the like emitted from the DMFC 1110 at around 70° C. are sufficiently condensed by the heat exchanger 1150. This can eliminate the need to supply moisture from exterior, and avoid methanol from being released to outside with an increase in consumption.

An air vent 1176 is formed in the case 1170 above the buffer tank 1130. The buffer tank 1130 is used as a dilute tank for diluting methanol from the methanol tank 1120 into predetermined concentrations (0.8 to 1.5 mol/L; in this practical example, 1.2 mol/L or so). The buffer tank 1130 is also used as a gas-liquid separation unit intended for the air, the produced water, the methanol aqueous, carbon dioxide, and the like that flow in after sufficiently cooled by the heat exchanger 1150. That is, the air and carbon dioxide of the gaseous phase in the buffer tank 1130 are emitted out of the air vent 1176. The air vent 1176 is provided with a not-shown filter so that such by-products as formic acids and formaldehyde are absorbed by the filter when the air and carbon dioxide are emitted out of the air vent 1176.

The buffer tank 1130 is supplied with a high-concentration methanol aqueous solution or pure methanol from the methanol tank 1120 periodically, or when the concentration of the methanol aqueous solution in the buffer tank 1130 is monitored and detected to fall below a predetermined threshold, e.g., 0.8 mol/L. The methanol tank 1120 accommodates a pack 1122 which is made of a flexible material having resistance against methanol. Walls 1124 of the methanol tank 1120 (a top 1124a, a side 1124b, and a back 1124c) constitute part of the case 1170. When the methanol in the methanol tank 1120 is consumed and the pack 1122 inside decreases in volume, a differential pressure can occur between the interior of the methanol tank 1120 around the pack 1122 and the exterior of the fuel cell system 1100. The back 1124c is thus provided with an air vent 1178 for avoiding this differential pressure.

As shown in FIG. 12, the control unit 1140 is configured detachable (separable) from a fuel cell unit 1192. The reference numeral 1142 represents a communication unit which establishes electric connection between the fuel cell unit 1192 and the control unit 1140. The communication unit 1142 forms a sealed space inside the fuel cell unit 1192 so as to forbid water vapor and the like. The communication unit 1142 is capable of communication and power exchange with the control unit 1140 via a connector 1144. The connector 1144 is inserted into an insertion part 1146 of the control unit 1140. The control unit 1140 can be replaced depending on the target for the fuel cell system 1100 of the present invention to supply power to. In this practical example, the control unit 1140 is shaped so that the bottom of a notebook PC can be placed thereon for the sake of supplying power to the PC. Since the control unit 1140 itself produces heat during operation, air vents 1179a and 1179b are formed in a side and the top thereof. When the fuel cell unit 1192 and the control unit 1140 are configured separable, or the control unit 1140 is configured replaceable depending on the target of power supply, the fuel cell unit 1192 for power generation can be rendered common for various applications.

### PRACTICAL EXAMPLE 3

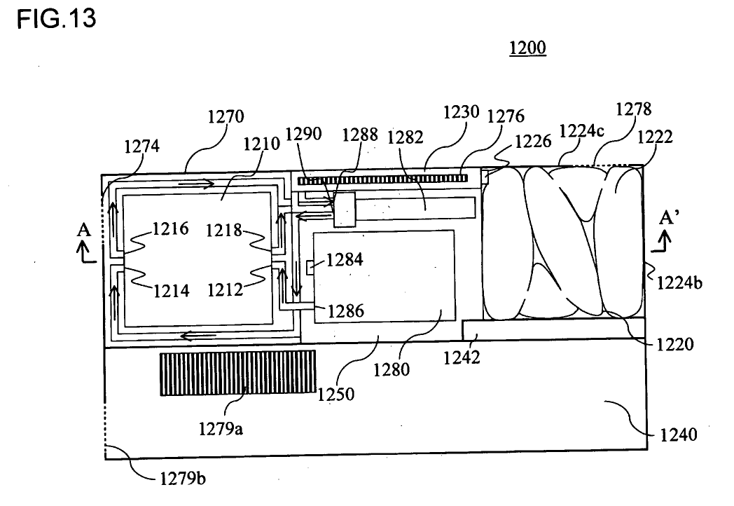

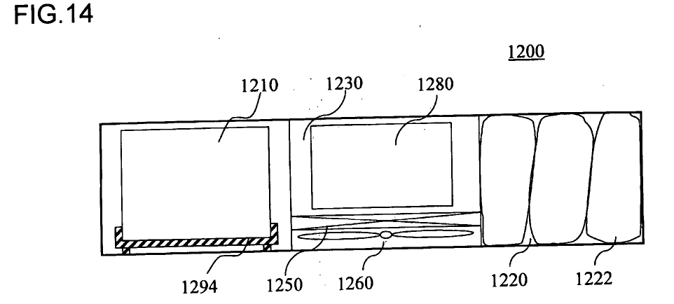

FIG. 13 is a schematic top view showing the configuration of a fuel cell system 1200. The fuel cell system 1200 comprises a DMFC 1210, a methanol tank 1220, a buffer tank 1230, a control unit 1240, a heat exchanger 1250, a single-suction sirocco fan 1260 (shown in FIG. 14), and a case 1270. A methanol aqueous solution or pure methanol is fed to the anode of the DMFC 1210 for power generation. The methanol tank 1220 contains a high-concentration methanol aqueous solution of or above 16 mol/L, or pure methanol. The methanol from the methanol tank 1220 is diluted into concentrations of 0.1 to 2.0 mol/L or so, and reserved in the buffer tank 1230 as the methanol aqueous solution to be fed to the DMFC 1210. The control unit 1240 exercises control on power conversion units and accessories.

An air pump 1280 feeds air to the cathode of the DMFC 1210. The anode is fed with the methanol aqueous solution from the buffer tank 1230 via a liquid pump 1282. The reference numeral 1284 represents an air intake of the air pump 1280, which is formed in the center of this fuel cell system 1200. The air introduced from the air intake 1284 of the air pump 1280 is delivered from an air discharge opening 1286 into a cathode inlet 1212 of the DMFC 1210. Meanwhile, the liquid pump 1282 is configured so that the methanol aqueous solution diluted to concentrations of 1.2 mol/L or so is introduced from the buffer tank 1230 to a liquid intake 1288, and delivered from a liquid discharge opening 1290 into an anode inlet 1214 of the DMFC 1210.

FIG. 14 is a schematic sectional view taken along the line A-A′ of FIG. 13. In this practical example, the single-suction sirocco fan 1260 attached to the bottom of the fuel cell system 1200 starts operation when the temperature of the DMFC 1210 approaches 55° C. as in practical example 2. An air vent of the single-suction sirocco fan 1260 is formed in the back side of the fuel cell system 1200. An air vent 1274 is formed in a position beyond the DMFC 1210. Thus, when the single-suction sirocco fan 1260 starts operation, the air introduced from the air vent formed in the back side of the fuel cell system 1200 via the single-suction fan 1260 initially cools the heat exchanger 250. Then, part of the air is taken into the air pump 1280 while the rest flows around the DMFC 1210 to cool the DMFC 1210, whereby the temperature of the DMFC 1210 is adjusted to 60° C.±3° C. As shown in FIG. 14, the DMFC 1210 is supported by a bottom support 1294 which is made of a resin having an excellent resistance against methanol. Thus, the air can also flow over the bottom of the DMFC 1210.

The cathode of the DMFC 1210 emits the air and the produced water from a cathode outlet 1216. The anode of the DMFC 1210 emits the methanol aqueous solution and carbon dioxide from an anode outlet 1218. The emissions from the cathode outlet 1216 and the anode outlet 1218 are introduced into the heat exchanger 1250, and flow into the buffer tank 1230 together. The air, the produced water, the methanol aqueous solution, carbon dioxide, and the like emitted from the DMFC 1210 at around 70° C. are sufficiently condensed by the heat exchanger 1250. This can eliminate the need to supply moisture from exterior, and avoid methanol from being released to outside with an increase in consumption.

While this practical example has dealt with the case of using the single-suction sirocco fan 1260, the fan is not limited to this type. As in practical example 2, an axial fan may be used. The use of the axial fan requires, however, that legs be formed on the bottom of the case of the fuel cell system 1200 and an air vent be formed in the bottom of the case, in a position opposite to the axial fan.

### INDUSTRIAL APPLICABILITY

The present embodiment can be used to reduce accessory power consumption not only in a DMFC system intended for portable equipment, which supplies power to a notebook PC or the like, but also in a fuel cell system for car-mounted applications. It is also possible to reduce the parts count for compact system configuration.

What is claimed is:

1. A fuel cell system comprising:
a fuel cell which generates electric power by using liquid fuel;
a fuel feed unit which feeds the liquid fuel to the fuel cell;
an emission recovery unit which recovers emissions from the fuel cell; and
a heat medium feed unit which feeds a heat medium for cooling the emissions to the emission recovery unit, wherein
the heat medium cools the fuel cell.

2. The fuel cell system according to claim 1, wherein the emission recovery unit is provided with a heat exchange unit which conducts heat exchange between the heat medium and the emissions, and conducts heat exchange between the liquid fuel to be fed to the fuel cell and the emissions.

3. The fuel cell system according to claim 1, wherein the heat medium is a fluid that lies outside the fuel cell system, and the heat medium is discharged to outside the fuel cell system after it cools the fuel cell and the emissions.

4. The fuel cell system according to claim 2, wherein the heat medium is a fluid that lies outside the fuel cell system, and the heat medium is discharged to outside the fuel cell system after it cools the fuel cell and the emissions.

5. The fuel cell system according to claim 1, comprising:
an internal fuel cell chamber in which the fuel cell and the emission recovery unit are arranged;
a heat medium inlet part formed on the fuel cell chamber, through which the heat medium flows into the fuel cell chamber; and
a heat medium outlet part formed on the fuel cell chamber, through which the heat medium flows out of the fuel cell chamber, and wherein
the heat medium flowing through the fuel cell chamber is let in through the heat medium inlet part alone and let out through the heat medium outlet part alone.

6. The fuel cell system according to claim 2, comprising:
an internal fuel cell chamber in which the fuel cell and the emission recovery unit are arranged;
a heat medium inlet part formed on the fuel cell chamber, through which the heat medium flows into the fuel cell chamber; and
a heat medium outlet part formed on the fuel cell chamber, through which the heat medium flows out of the fuel cell chamber, and wherein
the heat medium flowing through the fuel cell chamber is let in through the heat medium inlet part alone and let out through the heat medium outlet part alone.

7. The fuel cell system according to claim 3, comprising:
an internal fuel cell chamber in which the fuel cell and the emission recovery unit are arranged;
a heat medium inlet part formed on the fuel cell chamber, through which the heat medium flows into the fuel cell chamber; and
a heat medium outlet part formed on the fuel cell chamber, through which the heat medium flows out of the fuel cell chamber, and wherein
the heat medium flowing through the fuel cell chamber is let in through the heat medium inlet part alone and let out through the heat medium outlet part alone.

8. The fuel cell system according to claim 5, wherein the fuel cell and the heat medium inlet part are arranged next to each other.

9. The fuel cell system according to claim 6, wherein the fuel cell and the heat medium inlet part are arranged next to each other.

10. The fuel cell system according to claim 7, wherein the fuel cell and the heat medium inlet part are arranged next to each other.

11. The fuel cell system according to claim 6, wherein the heat exchange unit and the heat medium outlet part are arranged next to each other.

12. The fuel cell system according to claim 9, wherein the heat exchange unit and the heat medium outlet part are arranged next to each other.

13. The fuel cell system according to claim 1, wherein:
the fuel cell has a polygonal shape; and
at least one of sides of the fuel cell is put next to the flow channel of the heat medium.

14. A fuel cell system comprising:
a fuel cell which generates electric power from fuel and oxygen in air;
an air feed unit which feeds the air to the fuel cell; and
an air flow channel which introduces the air from outside the fuel cell system and exhausts air inside the fuel cell system to outside, wherein
an air intake of the air feed unit is formed in the air flow channel.

15. The fuel cell system according to claim 14, wherein the fuel cell is arranged in the air flow channel.

16. The fuel cell system according to claim 14, wherein the fuel may be liquid fuel.

17. The fuel cell system according to claim 15, wherein the fuel may be liquid fuel.

18. The fuel cell system according to claim 14, comprising a heat exchanger which conducts heat exchange between the air and emissions emitted from the fuel cell, and wherein
the heat exchanger is arranged in the air flow channel.

19. The fuel cell system according to claim 14, comprising a fuel cell unit including the fuel cell, and a control unit which controls the fuel cell, wherein
the fuel cell unit and the control unit are configured separable from each other.
